(19) United States
(12) Patent Application Publication
(10) Pub. No.: US 2011/0093958 A1
(43) Pub. Date: Apr. 21, 2011

(54) Secure Data Storage Apparatus and Method

(76) Inventor: Gilles Bruno Marie Devictor, Milpitas, CA (US)

(21) Appl. No.: 12/909,725

(22) Filed: Oct. 21, 2010

Related U.S. Application Data
(60) Provisional application No. 61/253,801, filed on Oct. 21, 2009.

(51) Int. Cl. G06F 21/24

(52) U.S. Cl. 726/26

(57) ABSTRACT

More and more personal or confidential information is stored in storage devices such as but not limited to, laptops, cell phones or USB keys, which are mobile per essence. Due to their mobility, such devices tend to be left unattended or even be lost, compromising the security of the data. This invention is a method to prevent access to the data on a mobile storage device when the intended recipient or user is not in closed range. The invention relies on the use of wireless communication protocol such as but not limited to RF, Bluetooth or Wi-fi to pair a security device with the storage device to enable its functionality. When the security device is not in communication range of the storage device, the data is made inaccessible. A data storage device may include a wireless communication interface used to secure the data, wherein the data storage is partitioned, with each partition having a different security profile.

### BACKGROUND

The invention relates to an apparatus and method of preventing unauthorized access to data stored on a mobile device.

### DESCRIPTION OF RELATED ART

Traditionally, stored data is protected through the mean of a password. Those traditional methods require that the users manually provide their identifier for each data access. Those methods also require the installation of specialized drivers in the host machine of the storage device. So, for example, a secured USB key could only be accessed on computer on which the security software has been installed, preventing their use as back-up or data transfer systems.

### BRIEF DESCRIPTION OF THE DRAWINGS

FIG. 1 shows a possible embodiment of the invention, in which a control device (101) is used to manage all data and information exchange within the secure storage system

FIGS. 2 and 3 show possible embodiments in which the data path and the security subsystem are decoupled as to accelerate data exchange between the secure storage system and its host

FIG. 4 shows a possible implementation in which the secure storage is used to enable a function depending on the presence of a reference device in close proximity.

FIG. 5 shows a possible implementation in which the function of the secure storage is enabled or disabled by a host system, depending on the presence of a reference design in close proximity.

### DETAILED DESCRIPTION

According to one embodiment of the invention, the storage device may be equipped with a short range wireless subsystem, including a radio. The storage device may utilize the wireless subsystem to detect the presence of a reference wireless device, such as a cell phone, laptop or specially designed device within a close proximity. Once the reference device is detected, the data storage device becomes accessible. In one embodiment, if the reference device is absent from the wireless range, protective actions may be taken by the storage device, such as locking access to the data, erasing the data, or sending an alarm message.

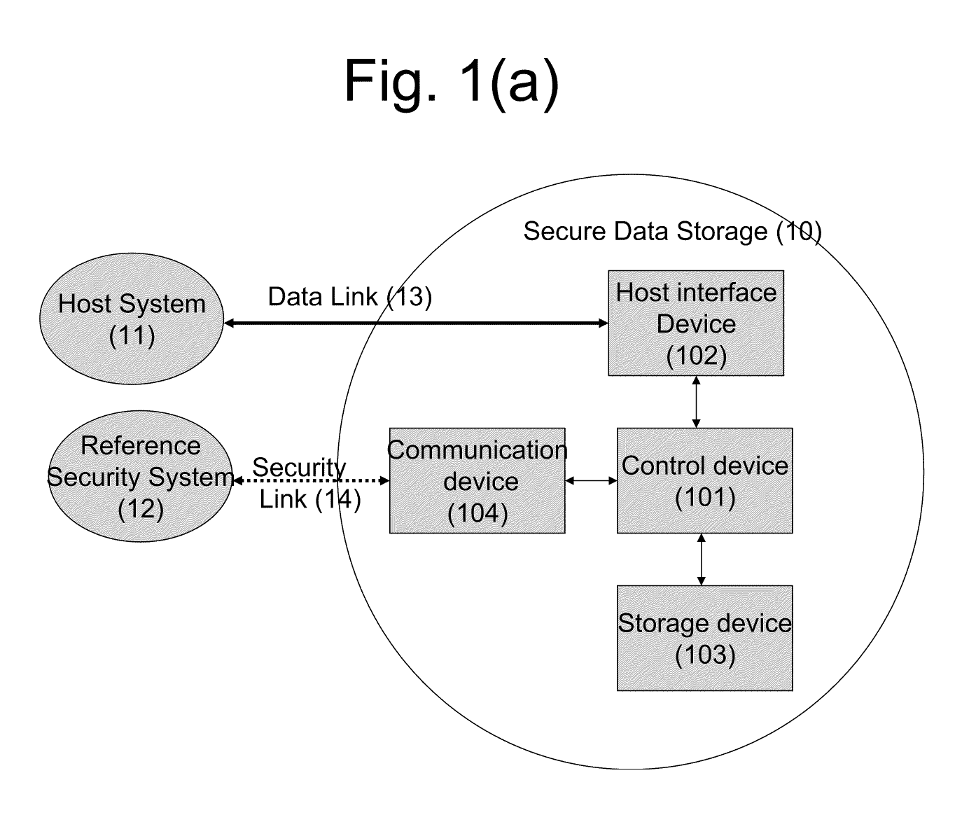

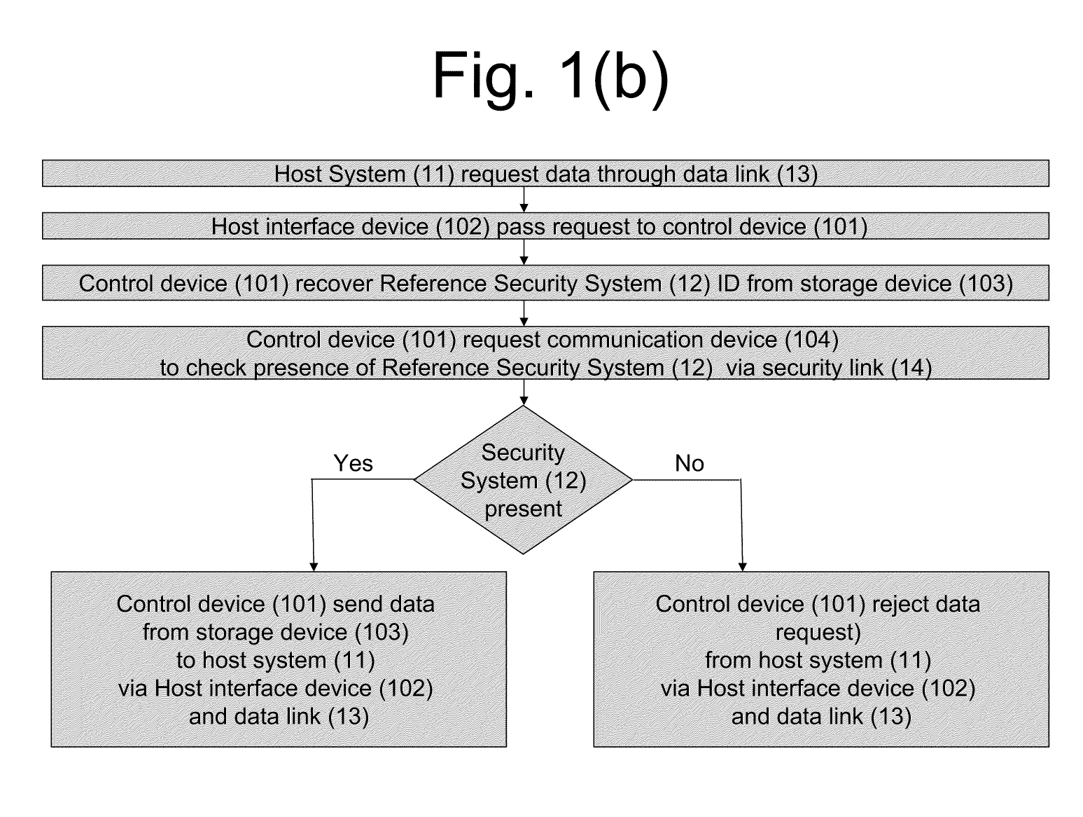

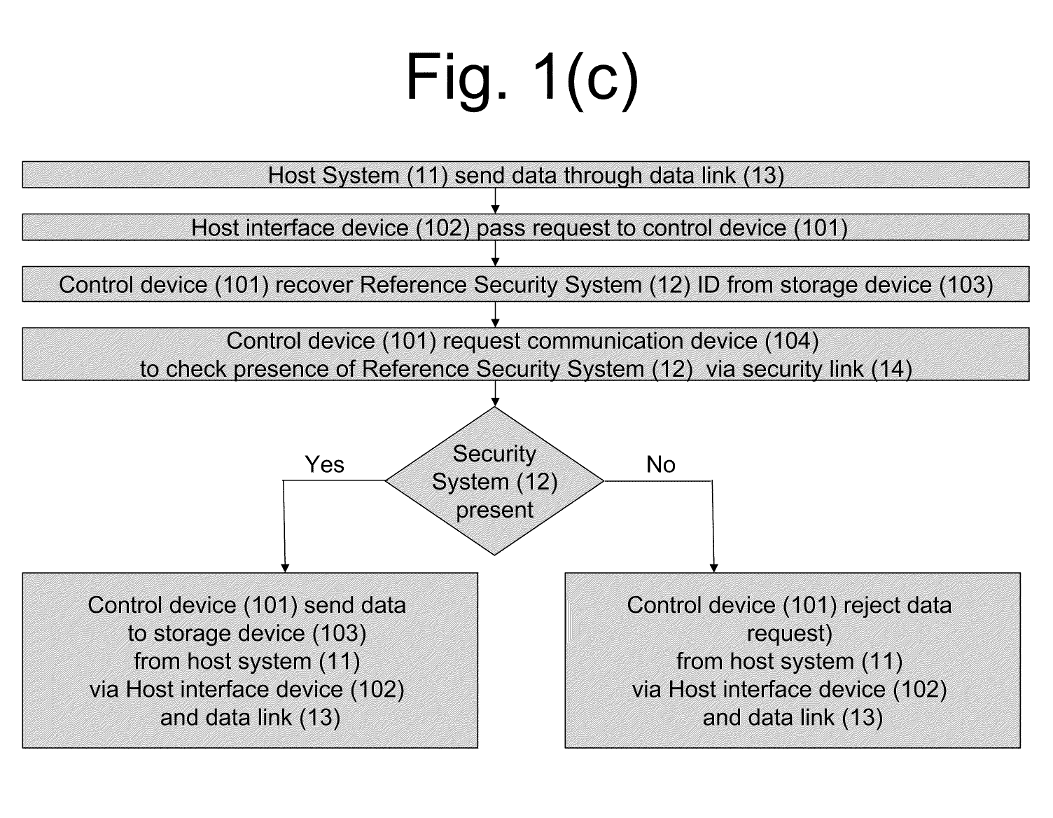

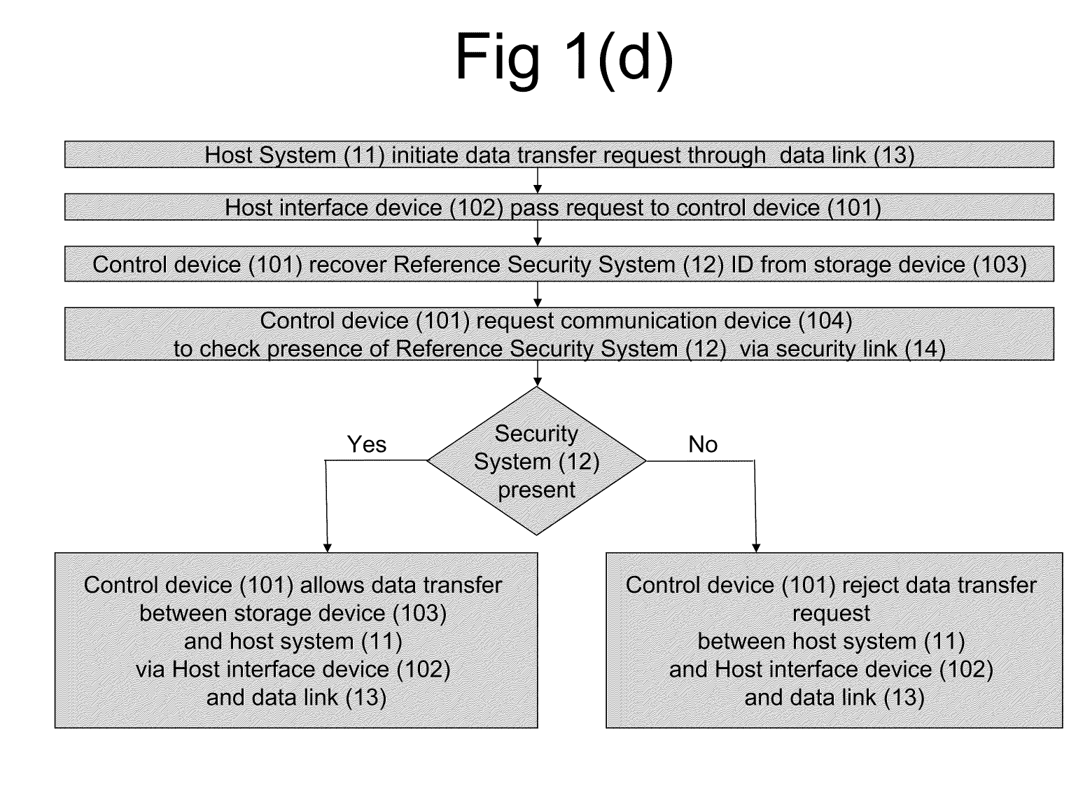

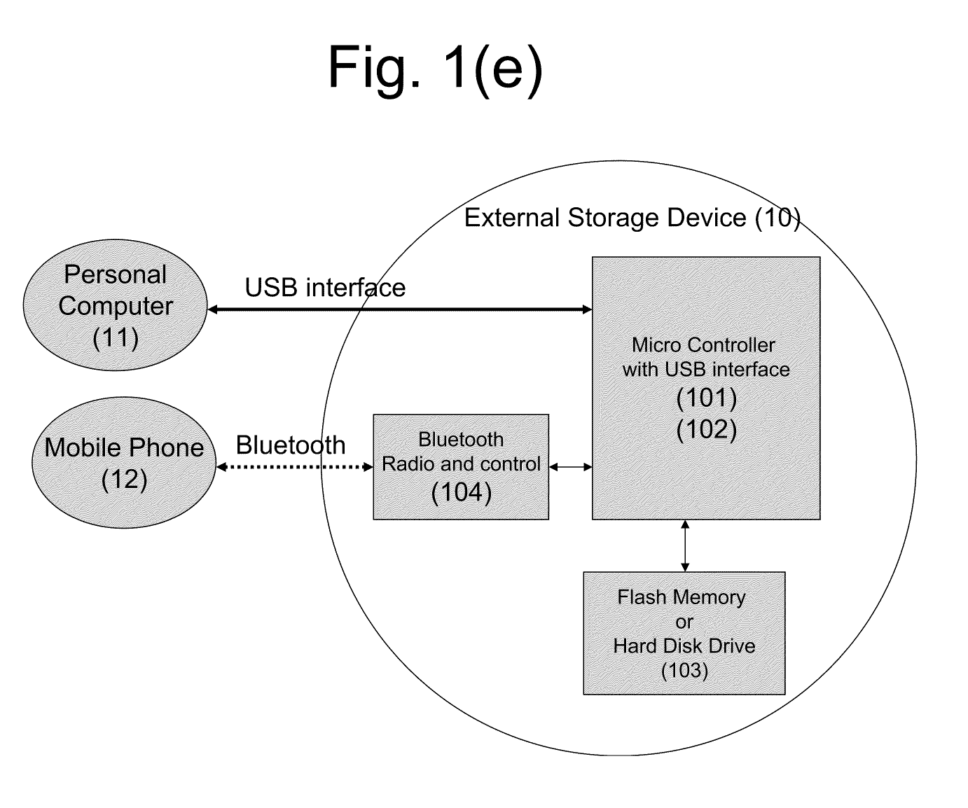

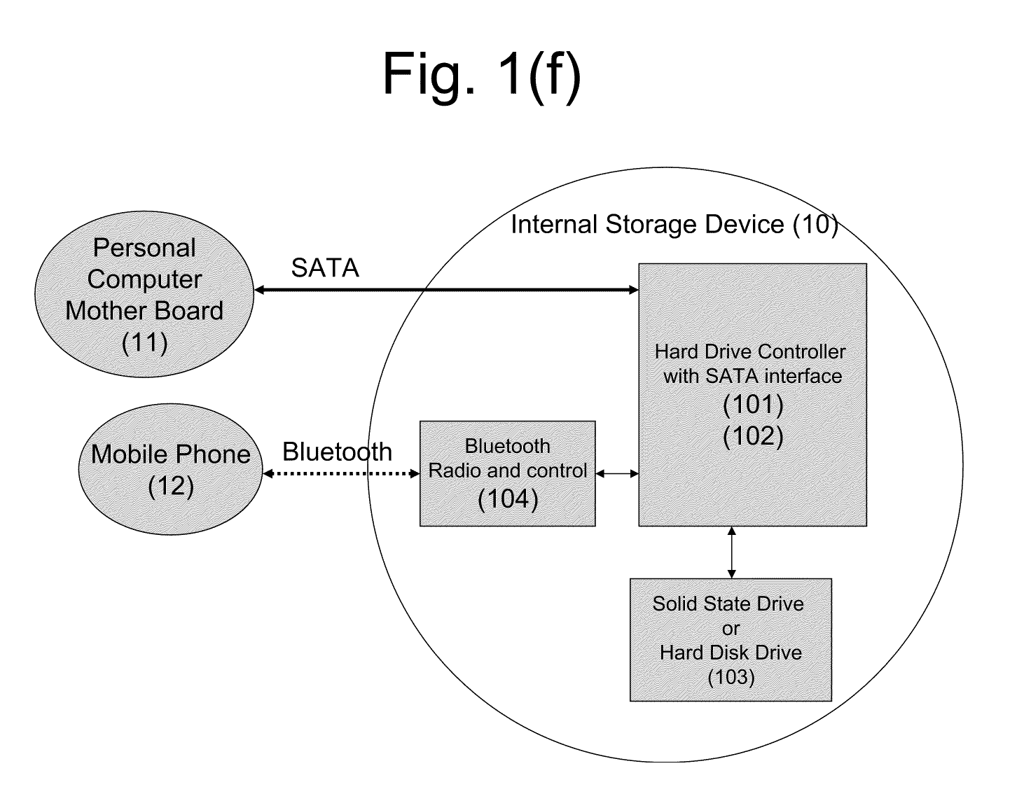

Referring to FIG. 1, in one embodiment, the secure data storage (10) may be made up of four different devices: a host interface device (102) that connects to host systems (11) such as computers or servers for example, using a data link (13) such as USB, SATA or others; a storage device (103) such as but not exclusive to a flash optical storage; a communication device (104) using protocols such as but not exclusive to Bluetooth or RF_ID to detect the presence of a reference security system (12) such as, but not exclusive to, a cell phone or an RF-ID tag; and a control device (101), such as but not exclusive to a micro-controller or micro-processor. In this embodiment, the Host System (11) performs a data access request through the data link (13). The Host Interface Device (102) notifies the Control Device (101) that a data request took place. The Control Device (101) then asks the Communication Device (104) to check for the presence of the Reference Security System (12) in the vicinity. For example, in the case of a Bluetooth protocol, the Communication Device (104) will check that a Phone with the right ID is present. If the Reference Security System (12) is detected, the data access is granted to the Host System (11). Note that the Reference Security System (12) ID can be stored in the Storage Device (103) or any other storage device in the apparatus. The apparatus might be kept in an unlocked state until a Reference Security System (12) is associated to it by the user, or can be associated to a Reference Security System in the factory. An example of factory association would be to associate a secured USB storage key with one or more key chain RF ID tags.

In another embodiment, the Storage Device (103) can be partitioned. Each partition may be associated to one or more Reference Security System (12), a map of those associations can then be stored in the apparatus. The map might be a separate partition in the storage device (103) associated to its own Reference Security System (12). The map can then only be modified if its Reference Security System (103) is present. One example application would be in a business environment where the user of a laptop or USB key will have access to a storage partition using their badge equipped with an RF-ID tag while the IT department will have access to the partition map using a separate badge, allowing them to reset the partition association in case of incident such as the loss of the employee badge.

In another embodiment, the Secure Storage (10) may use build-in feature of the protocol used as the security link (14) to establish a connection with the Reference Security System (12) and only unlock access to the Storage Device (103) when this connection is established. In such case, access to the Storage Device (103) is blocked as soon as the connection between the Reference Security System (12) and Secure Storage (10) is broken.

In another embodiment, the secure Storage would be USB key or external Hard drive associated to a cell phone via Bluetooth. In this embodiment, the Personal Computer (11) performs a data access request through the USB interface (13). The microcontroller (101) build in the Storage device (10) check for the presence of the Mobile Phone (12) using the built-in Bluetooth radio (104). The close Range nature of Bluetooth ensures that the Mobile Phone can only be detected when in close proximity. If the Mobile Phone (12) is detected, the data access is granted to the Host System (11). In such an embodiment, the associated mobile phone unique ID can be stored in storage (103).

In another embodiment described in FIG. 1 (f), the secure Storage would be an internal Hard drive associated to a cell phone via a built-in Bluetooth. In this embodiment, the Personal Computer's Motherboard (11) performs a data access request through the SATA interface (13). The microcontroller (101) build in the Storage device (10) check for the presence of the Mobile Phone (12) using the built-in Bluetooth radio (104). The close Range nature of Bluetooth ensures that the mobile Phone can only be detected when in close proximity. If the Mobile Phone (12) is detected, the data access is granted to the Mother Board (11). In such an embodiment, the associated mobile phone unique ID can be stored in storage (103).

In another embodiment described in FIG. 1 (g), the secure Storage would be an external Storage Device associated to a card or badge equipped with a RFID chip. In this embodiment, the Personal Computer (11) performs a data access request through the USB interface (13). The microcontroller (101) build in the Storage device (10) check for the presence of the associated Card or Badge (12) using the built-in RFID radio (104). The close Range nature of RFID ensures that the associated Card or Badge can only be detected when in close proximity. If associated Card or Badge (12) is detected, the data access is granted to the Personal Computer (11). In such an embodiment, the associated mobile phone unique ID can be stored in storage (103).

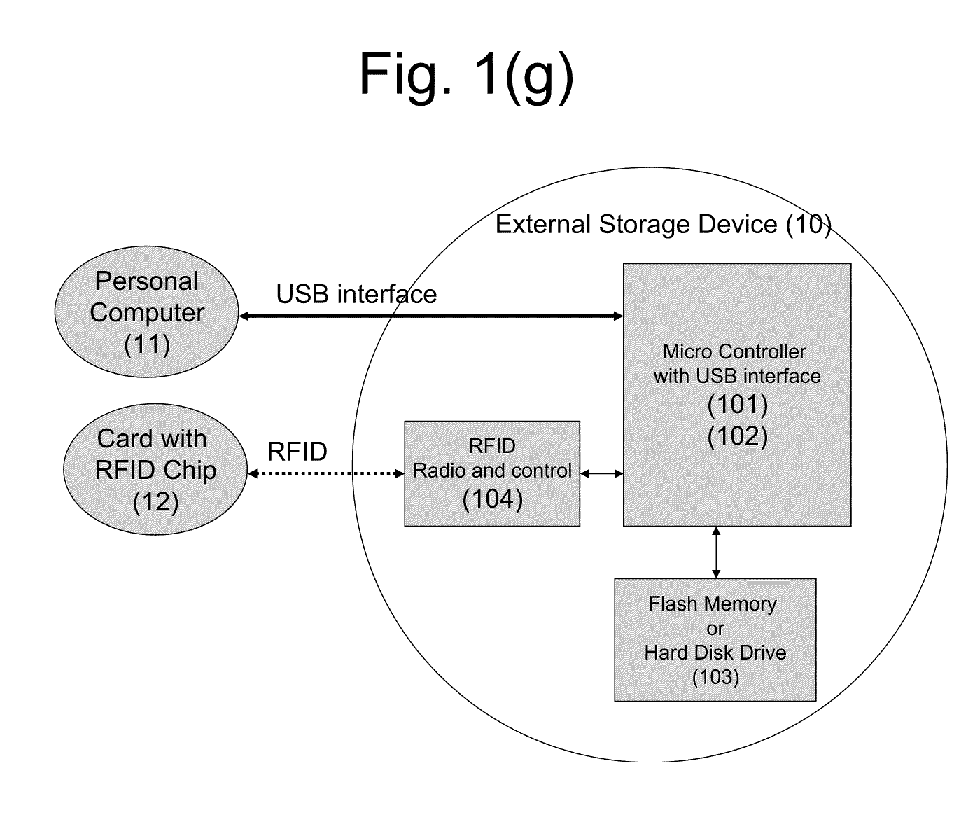

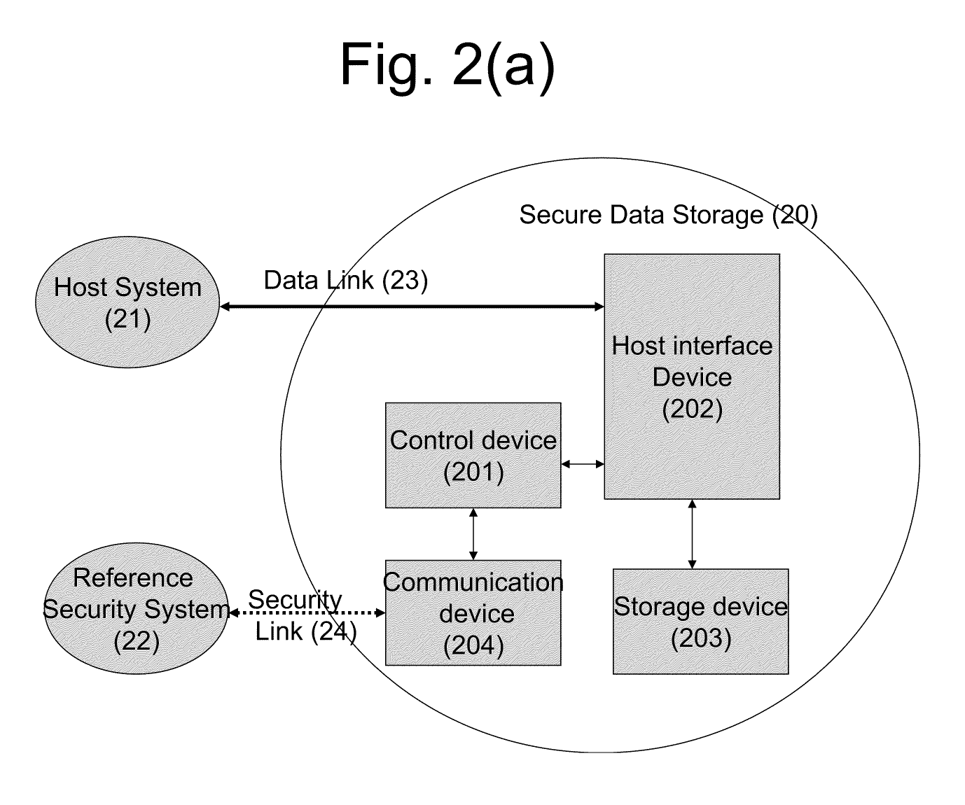

In another embodiment, referring to FIG. 2, the control device (204) is taken out of the data path as to increase the data exchange speed. In this embodiment, the control device is used to control the access rights through the host interface device (202).

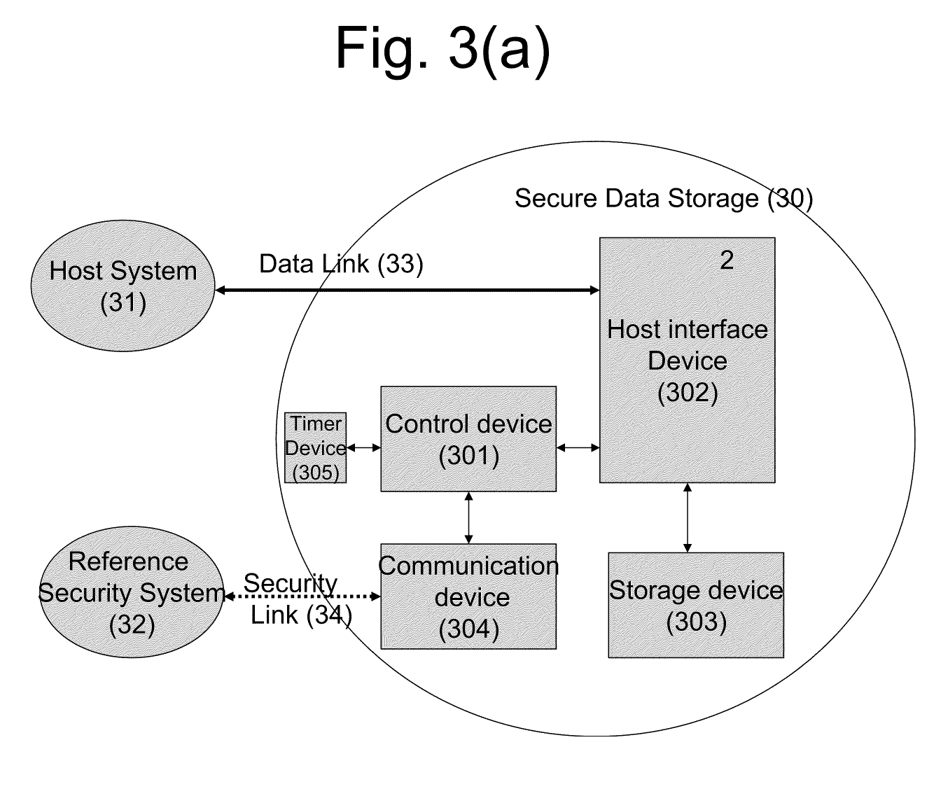

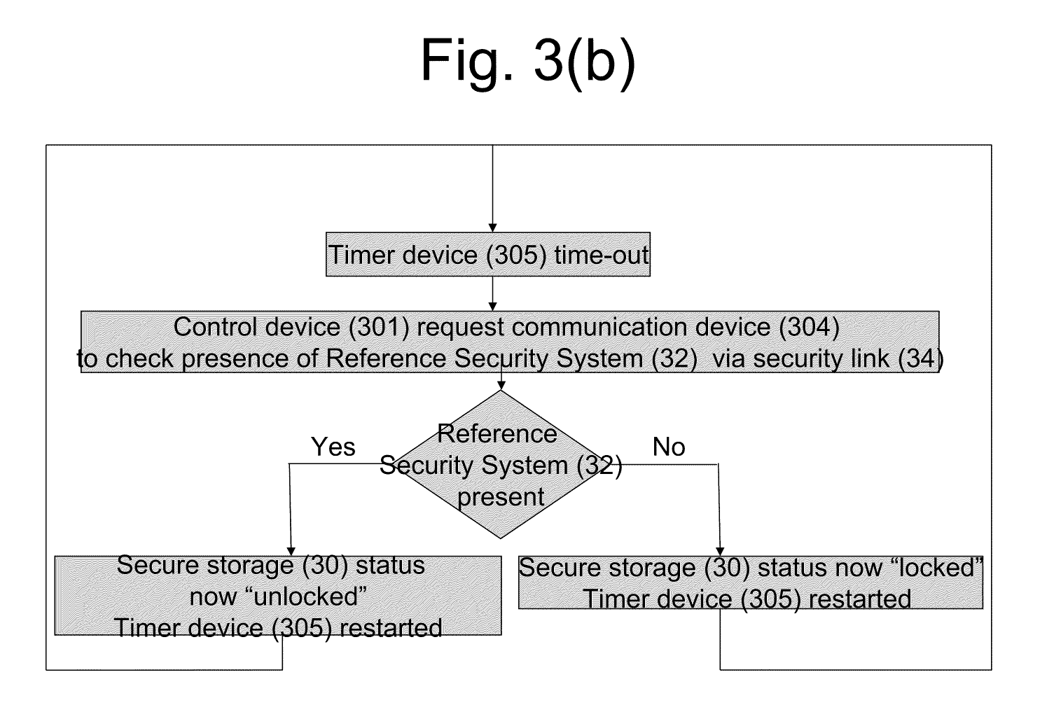

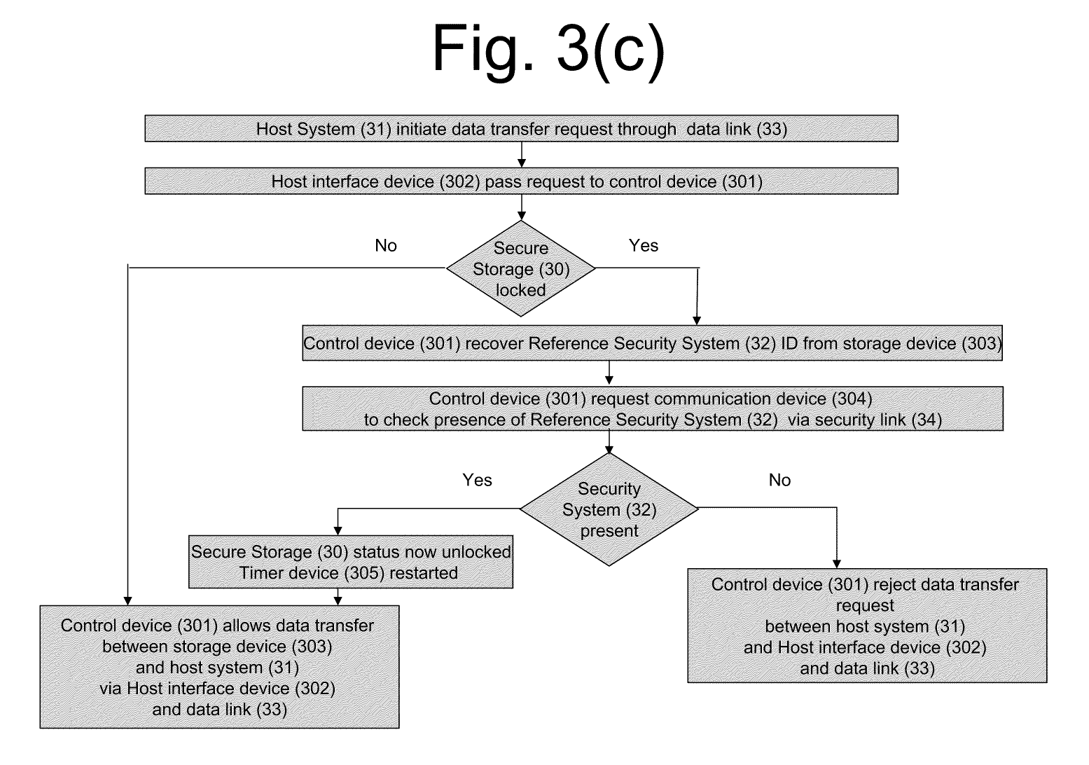

In another embodiment, referring to FIG. 3, a timer device (305) is added to the system as to conduct periodic check of the presence of the Reference Security System (32). If Reference Security Systems (32) are present, the Storage Device (103) partitions associated to them become unlocked until the next periodic check takes place. If some Reference Security Systems (32) are absent, the Storage Device (103) partitions associated to them become locked until the next periodic check takes place. If the Host System (31) tries to access a locked partition of the Data storage (303), the control device (301) will start the sequence to determine if the Reference Security Systems (32) is now present.

In another embodiment, the apparatus will take protective measures if a certain number of consecutive data access from the Host System have been rejected. Those measures could be such as erasing the data of the partition being targeted by the host system, encrypting the data of the partition being targeted by the host system, sending an alert message in the case of an apparatus connected to a communication network, adding a secondary level of security such as predetermined password.

In another embodiment, the security method can be combined with other method such as encryption and passwords.

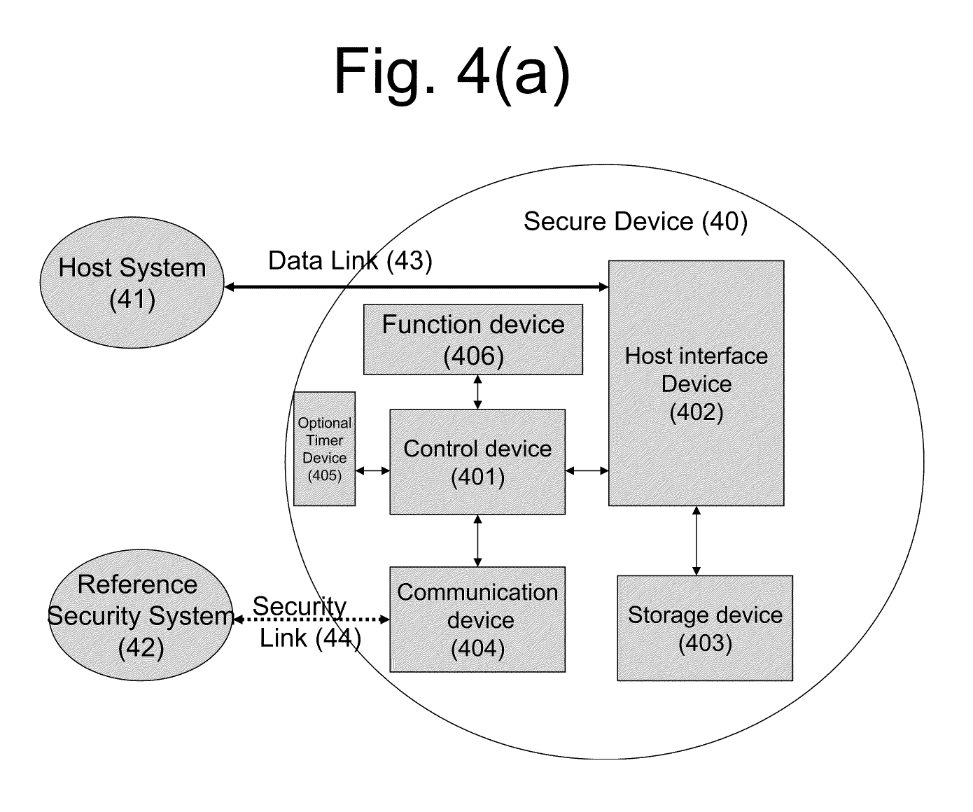

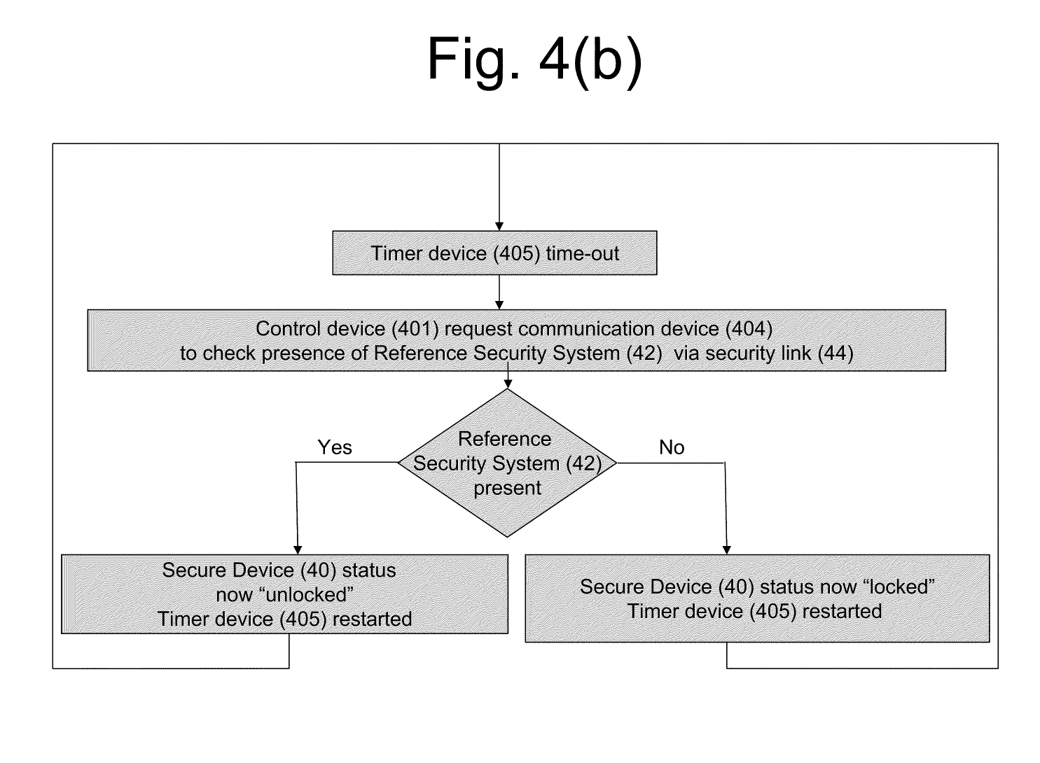

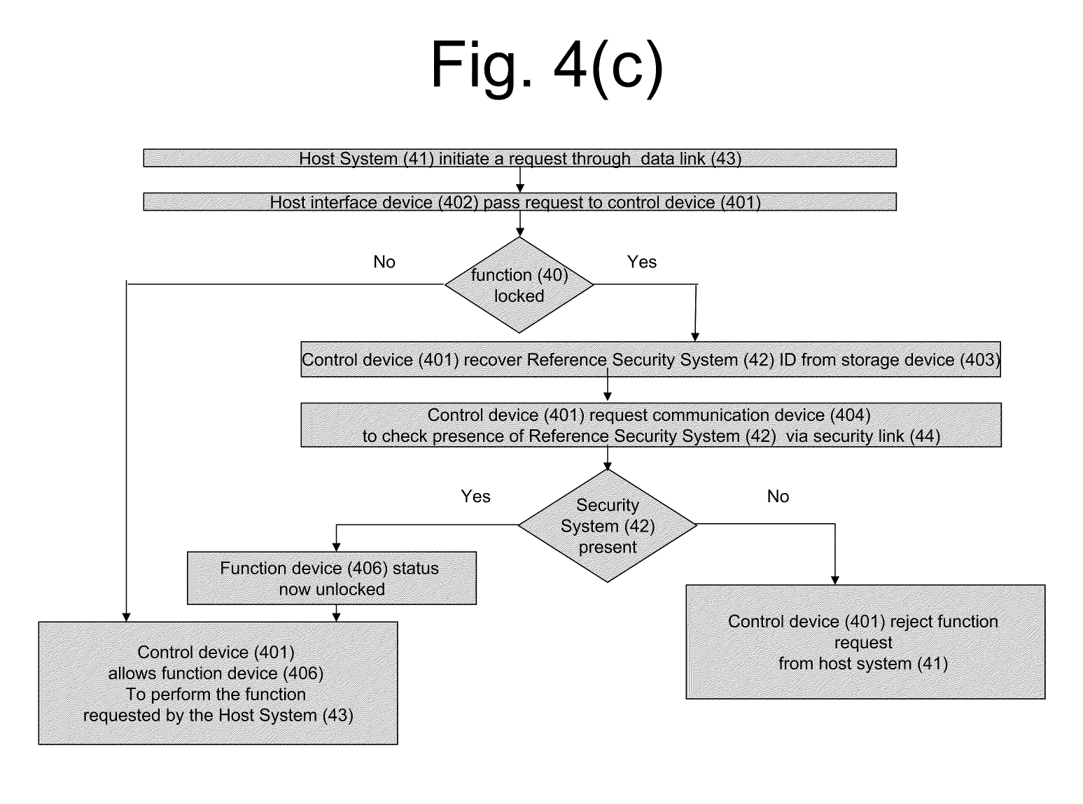

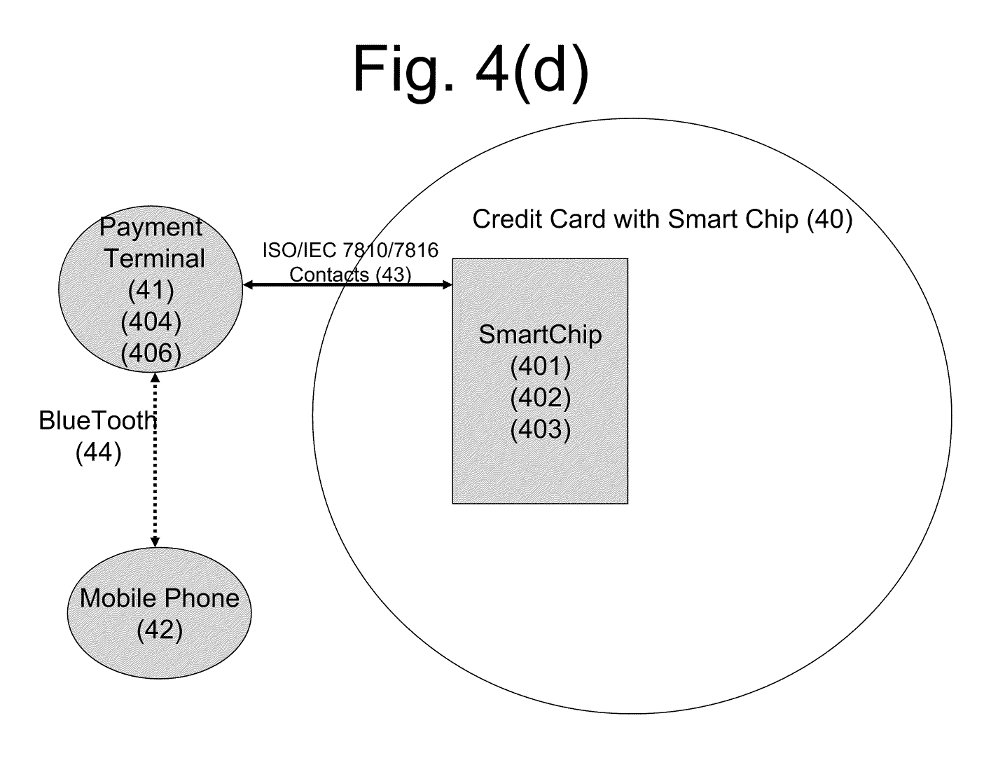

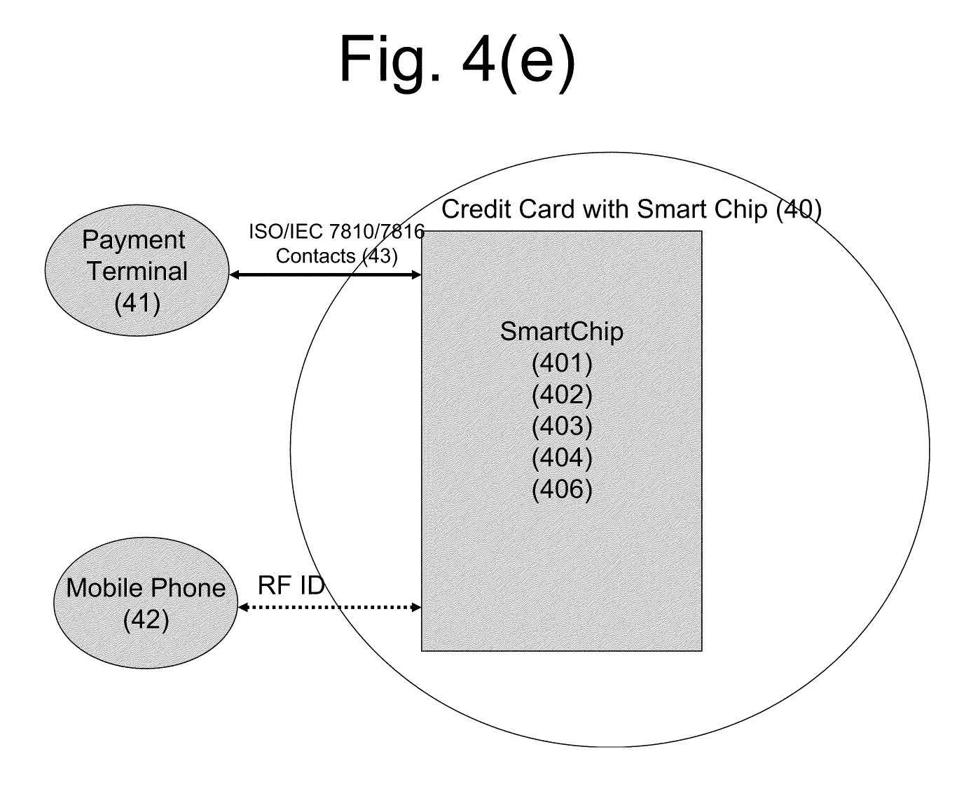

In another embodiment, referring to FIG. 4, the storage device (403) is used to store a map associating Reference Security Systems with predetermined functions of the Secure Device (40). When a Host System (41) request the Secure Device (40) to perform a function, the Secure Device (40) uses the method described above to check for the presence of the Reference Security System (42) associated with the function. Such an apparatus can be implemented on payment devices such as credit cards and only allows transactions to be made if the Reference Security System is present in the vicinity.

In such an embodiment, described in FIG. 4 (d), the Host System can be a credit card payment terminal (41) and the Secure Storage Device a credit card (40) equipped with a SmartChip (401). The payment terminal (41) will first request the Credit card SmartChip (401) to provide the ID of its associated Reference Security System, usually a mobile phone. The payment terminal will then use the Bluetooth or similar close range Protocol (44) to check for the presence of the Reference Security System (42) within Close Range. The credit card (40) usage will only be allowed by the payment terminal (41) if the Reference Security System (42) is detected.

In another embodiment, described in FIG. 4 (f), the Host System can be a credit card payment terminal (41) and the Secure Storage Device a credit card (40) equipped with a SmartChip (401) and an RFID radio. The Credit card SmartChip (401) will only provide information stored in its internal storage (403) to the payment terminal (41) if it can access its Reference Security System (42) using its built-in RFID radio. (404). The inherent short range nature of RFID will ensure that a detected Reference security system is within close range. The reference Security System may be a mobile phone or a card with built-in RFID chip.

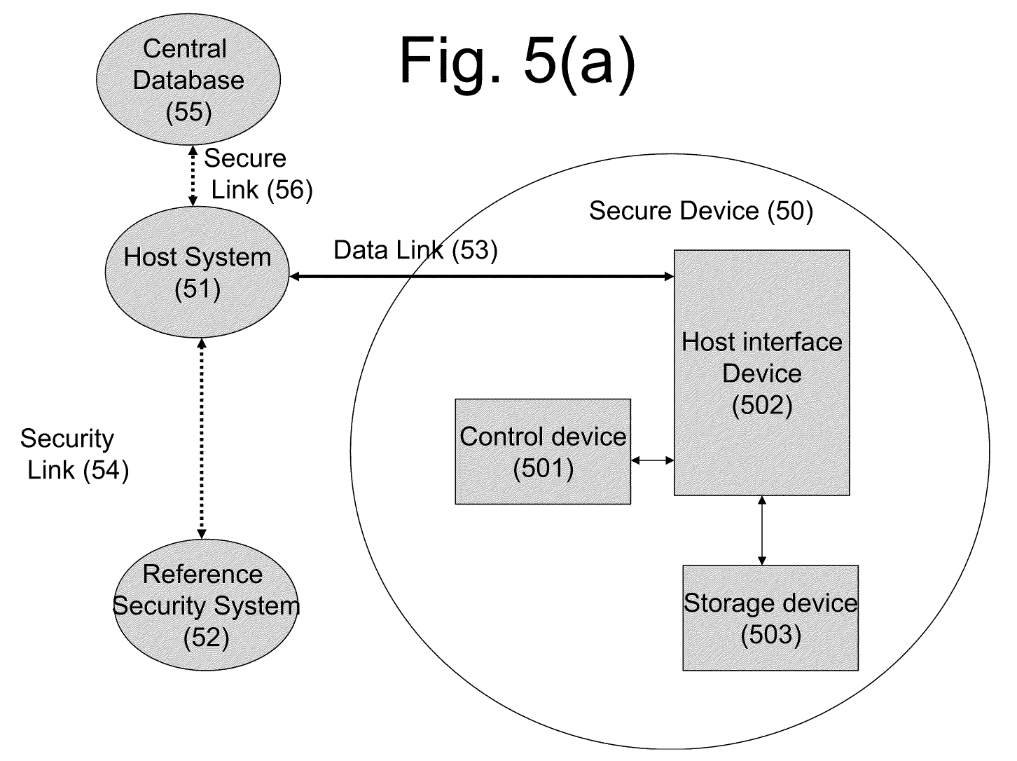

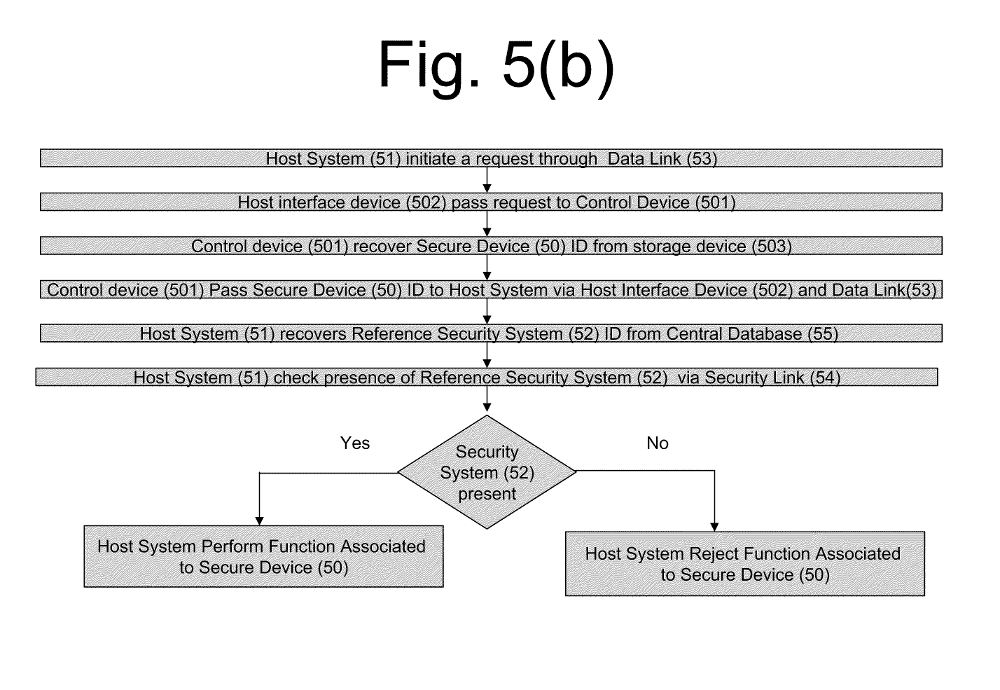

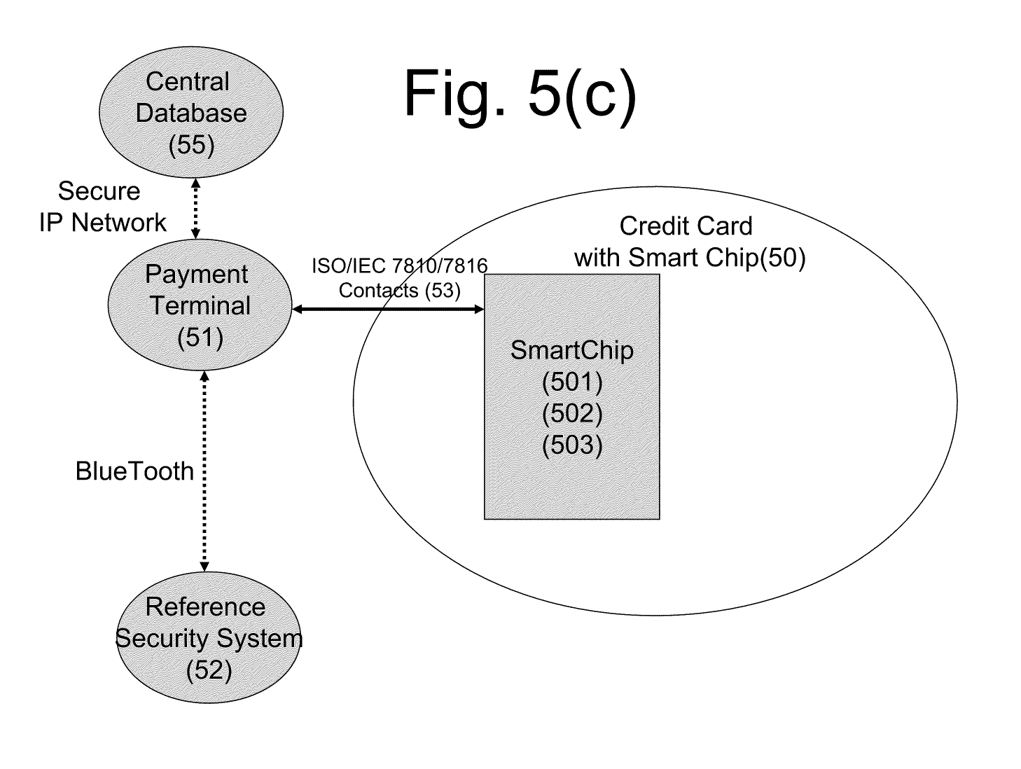

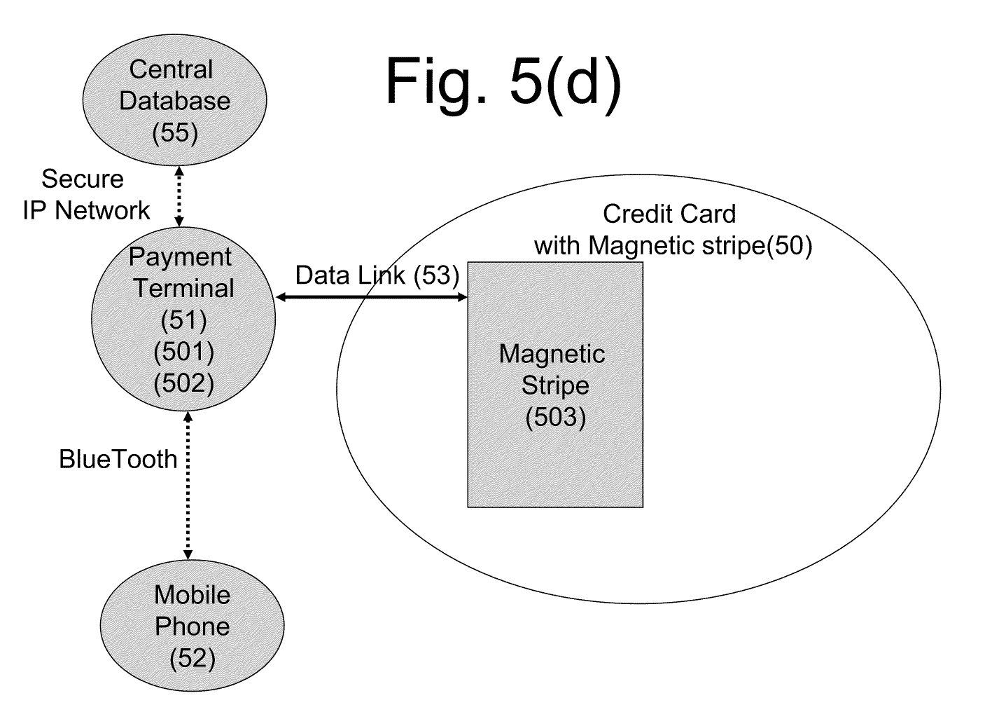

In another embodiment, described in FIG. 5, the host system (51) will first request the Secure Device (50) to provide its own ID stored in built-in storage device (503). The Host System (51) will then obtain the Reference Security System (52) ID from a central database (55) using the Secure Device (50) ID. The Host System will then use the Bluetooth or similar close range Protocol (54) to check for the presence of the Reference Security System (52) within Close Range. The function associated with the Secure Device (50) will only be performed by the host system if the Reference Security System (52) is detected within close range. The inherent short range nature of the security link (54) will ensure that a detected Reference Security System (52) is within close range.

In such an embodiment, described in FIG. 5 (c), the Host System can be a credit card payment terminal (51) and the Secure Storage Device a credit card (50) equipped with a SmartChip (501). The payment terminal (51) will first request the Credit card SmartChip (501) to provide its own ID. The payment terminal (51) will then obtain the Reference Security System (52) ID from a central database (55) using the SmartChip (501) ID. The payment terminal will then use the Bluetooth or similar close range Protocol (54) to check for the presence of the Reference Security System (52) within close range. The credit card (50) usage will only be allowed by the payment terminal (51) if the Reference Security System (52) is detected. The inherent short range nature of Bluetooth (54) will ensure that a detected Reference Security System (52) is within close range.

In another embodiment, described in FIG. 5 (b), the Host System can be a credit card payment terminal (51) and the Secure Storage Device a credit card (50) equipped with a Magnetic stripe (503). The payment terminal (51) will first read the credit card (50) ID from the Magnetic Stripe (503). The payment terminal (51) will then obtain the Reference Security System (52) ID from a central database (55) using the credit card (50) ID. The payment terminal will then use the Bluetooth or similar close range Protocol (54) to check for the presence of the Reference Security System (52) within close range. The credit card (50) usage will only be allowed by the payment terminal (51) if the Reference Security System (52) is detected.

Generally, in one embodiment, provided is a data storage device having of the storage itself and a wireless communication interface used to secure the data. Below are further examples of various other embodiments and features that may be included in such a device.

The data may be accessed via a USB protocol.

The wireless communication protocol used for securing the data may be RF-ID, Bluetooth, Wi-Fi or other protocols.

The data storage may be different types of memory, including a hard disk-drive, Flash, or other types of memory.

The data storage may be partitioned, with each partition having a different security profile, with some partitions being secured and some being unsecured

The data may be erased after a certain number of unsuccessful data access attempts.

The data storage device my include the storage itself and a wireless communication interface used to secure the data, wherein the data storage is partitioned, with each partition having a different security profile.

In the following disclosure, numerous specific details are set forth to provide a thorough understanding of the invention. However, those skilled in the art will appreciate that the invention may be practiced without such specific details. In other instances, well-known elements have been illustrated in schematic or block diagram form in order not to obscure the invention in unnecessary detail. Additionally, for the most part, details concerning network communications, data structures, and the like have been omitted inasmuch as such details are not considered necessary to obtain a complete understanding of the invention, and are considered to be within the understanding of persons of ordinary skill in the relevant art. It is further noted that all functions described herein may be performed in either hardware or software, or a combination thereof, unless indicated otherwise. Certain terms are used throughout this description and claims to refer to particular system components. As one skilled in the art will appreciate, components may be referred to by different names. This document does not intend to distinguish between components that differ in name, but not function. In the following discussion and in the claims, the terms “including”, “comprising”, and “incorporating” are used in an open-ended fashion, and thus should be interpreted to mean “including, but not limited to . . . ”. Also, the term “couple” or “couples” is intended to mean either an indirect or direct electrical or communicative connection. Thus, if a first device couples to a second device, that connection may be through a direct connection, or through an indirect connection via other devices and connections.

Within the different types of devices wherein the invention may be utilized, such as laptop or desktop computers, hand held devices with processors or processing logic, USB storage key and external hard Drive, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. As described above in reference to the figures, components included for storing and retrieving larger amounts of information such as data and software applications configured to perform functions according to the invention when executed by a central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

The term “machine-readable medium” or similar language should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the invention. The machine-readable medium includes any mechanism that provides (i.e., stores and/or transmits) information in a form readable by a machine (e.g., a computer, PDA, cellular telephone, etc.). For example, a machine-readable medium includes memory (such as described above); magnetic disk storage media; optical storage media; flash memory devices; biological electrical, mechanical systems; electrical, optical, acoustical or other form of propagated signals (e.g., carrier waves, infrared signals, digital signals, etc.). The device or machine-readable medium may include a micro-electromechanical system (MEMS), nanotechnology devices, organic, holographic, solid-state memory device and/or a rotating magnetic or optical disk. The device or machine-readable medium may be distributed when partitions of instructions have been separated into different machines, such as across an interconnection of computers or as different virtual machines.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The apparatus and method include a method and apparatus for enabling the invention. Although this embodiment is described and illustrated in the context of devices, systems and related methods of storing data, the scope of the invention extends to other applications where such functions are useful. Furthermore, while the foregoing description has been with reference to particular embodiments of the invention, it will be appreciated that these are only illustrative of the invention and that changes may be made to those embodiments without departing from the principles, the spirit and scope of the invention, the scope of which is defined by the appended claims, their equivalents, and also later submitted claims and their equivalents.

Although the invention has been particularly described with reference to embodiments thereof, it should be readily apparent to those of ordinary skill in the art that various changes, modifications and substitutes are intended within the form and details thereof, without departing from the spirit and scope of the invention. Accordingly, it will be appreciated that in numerous instances some features of the invention will be employed without a corresponding use of other features. Further, those skilled in the art will understand that variations can be made in the number and arrangement of components illustrated in the above figures. It is intended that the scope of the appended claims include such changes and modifications.

1. A storage device, comprising:
electronic storage media configured to store digital data;
a wireless communication system configured to verify the presence of a proximate device as to enable or disable a function, including a wireless detection system configured to detect proximate devices and to transmit digital data to, receive digital data from proximate devices and to store digital data on the electronic storage media.

2. A storage device according to claim 1, further configured to add additional layer of security on the stored data when the proximate device is not present.

3. A storage device according to claim 1, wherein the function is the authorization of making a payment.

4. A storage device, comprising:
electronic storage media configured to store digital data;
a data interface configured to transfer digital data between the electronic storage media and external devices.
a wireless communication system configured to verify the presence of a proximate device
a control system configured to regulate the data transfers through the data interface, based on the detection of the proximate device by the wireless communication system.

5. A storage device according to claim 4, further configured to disallow data transfers through its data interface when the proximate device is not detected by the wireless communication system.

6. A storage device according to claim 4, further configured to add additional layer of security on the stored data when the proximate device is not detected by the wireless communication system.

7. A storage device according to claim 4, further configured to add additional layer of security to data transfers when the proximate device is not detected by the wireless communication system.

8. A storage device according to claim 4, whereas the electronic storage media is partitioned, and the control system regulate data transfer to and from each partition differently.

9. A storage device according to claim 4, whereas the data interface uses the USB protocol.

10. A storage device according to claim 4, whereas the wireless communication system uses the Bluetooth protocol.
